(19) United States
(12) Patent Application Publication
(10) Pub. No.: US 2009/0011153 A1
(43) Pub. Date: Jan. 8, 2009

(54) LIGHTWEIGHT FIREPLACE CASTABLE LOG AND METHOD OF MANUFACTURE

(76) Inventor: Wayne SINSLEY, Karnack, TX (US)

Correspondence Address: DAVID G. HENRY, 418 RIVERVIEW DRIVE, WOODWAY, TX, 76712, US

(21) Appl. No.: 12/025,742

(22) Filed: Feb. 4, 2008

Related U.S. Application Data
(60) Provisional application No. 60/899,347, filed on Feb. 5, 2007.

(51) Int. Cl. B44F 7/00; B29C 35/16

(52) U.S. Cl. 428/18; 264/28

(57) ABSTRACT

The present invention relates to an improved molding process and composition for lightweight synthetic fiber logs used in natural gas, propane and wood burning fireplaces. A method of manufacturing castable fireplace logs comprising the combination of inorganic fibers with a binder carrier mix to form logs of superior color and detail in a shortened production time frame.

This is a request to convert underlying provisional patent application Ser. No. 60/899,347, filed 5 Feb. 2007, into a non-provisional application, and amendments adding claims in satisfaction of 35 U.S.C. 112 appear in this document. All fees for such conversion are paid contemporaneously with this filing.

### BACKGROUND OF THE INVENTION

1. Technical Field

This invention relates to artificial molded fireplace logs made of ceramic fibers, cement and cast methods to be used in gas fireplaces.

2. Background Information

Previous manufacturing methods and techniques have used a variety of different compounds, as in refractory ceramic fibers such as vitreous alumina-silica which is typically formed in a vacuum mold and then heated to bond the fibers into a coalesced mass, see for example U.S. Pat. Nos. 4,220,453, 5,271,888, 5,284,686, 6,077,467 and 6,447,906.

Applicant's own U.S. Pat. Nos. 888 and 875 disclose and claim vacuum molding ceramic and mineral fiber log formations using realistic molds and multiple step processes to batch mix binders and fibers, mold into a coalesce shape by vacuum and pressure and then heat curing to solidify, set and process the log.

### SUMMARY OF THE INVENTION

An artificial fireplace log manufacturing process and method in which a formulation of inorganic material comprised of vermiculite, clay and colloidal silica is combined and cast in a mold. Multiple processing step for log completion include flash freezing, oven drying and color coating provide for a total inorganic stable lightweight artificial log with a high color and detail retention of a durable high performance material.

### DESCRIPTION OF THE DRAWINGS

FIG. 1 is a process flow chart schematically defining the multiple steps of the disclosed process according to the present invention.

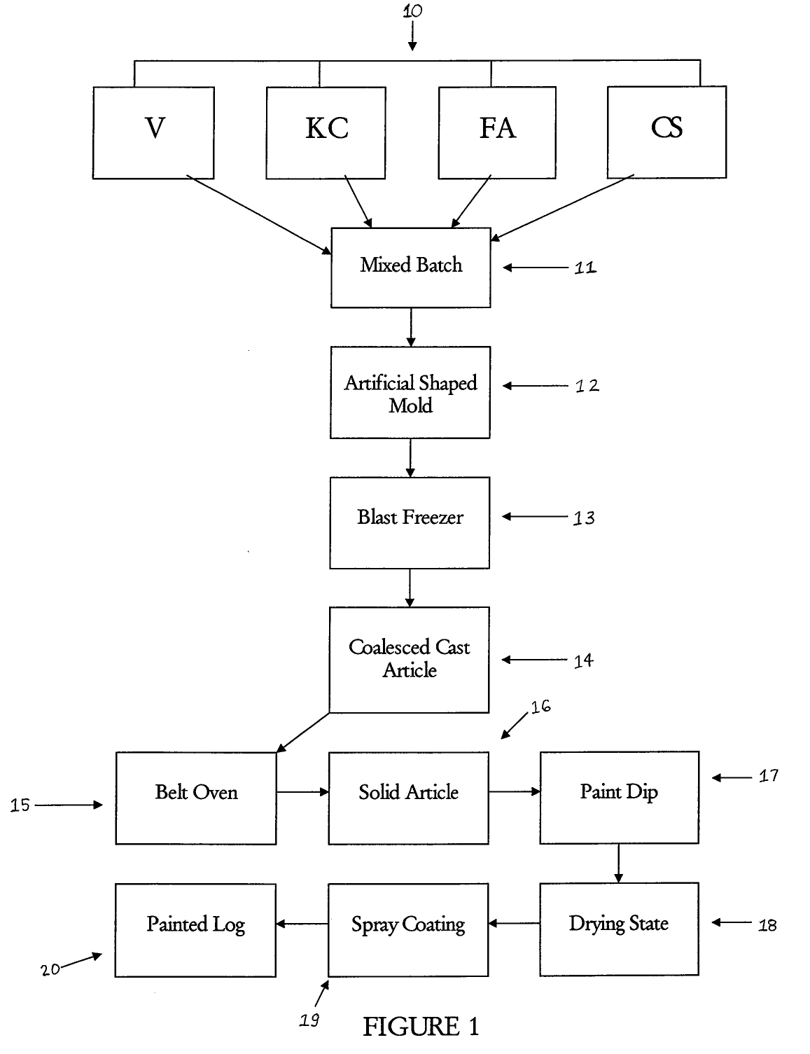

### DETAILED DESCRIPTION OF THE INVENTION

Referring to the FIGURE, a process of the invention can be seen in which a formulation of composite inorganic materials 10 is provided in a mixed batch 11 having by weight 80% processed vermiculite (V), 15% kaolin clay (KC) and 5% colloidal silica (CS). The processed vermiculite is by definition of a find particle granular size of 0.5-1 mm of a hydrated laminar magnesium aluminum iron silicate defining the base material of the formulation of the invention. Kaolin clay is a natural mineral of the alumina silicate chemical family with an opaque powder or granular composition in an unexfoliated form. Kaolin clay provides a fill binder in this application of the invention. Colloidal silica such as commonly available under the trademark BINDZIZ 1440 is used for bonding refractory fibers with high temperature resistance which is a 40% concentration of silica sol of 14 nanometers diameter amorphous silica spheres.

The method step of the process of the invention comprises forming a mixed batch of processed vermiculite, colloidal silica and kaolin clay and pouring it into an artificial shaped mold 12 which is of a natural log shaped configuration. The mold 12 may be of urethane or rubber depending on application use criteria. The filled molds 12 are then placed on a belt of a tunnel freezer (blast freezer) 13 at −35 to −40 centigrade for twenty to forty minutes. Freezing of the mixture molded log configuration crystallizing the coalesced silica for breaking it down as a bonding agent. Coalesced cast article 14 so formed is in a so-called “green” state that can be handled and thus is removed from the mold freeing the mold for reuse in a shortened mold cycle time.

The “green” state log article 14 so formed is then placed directly onto a belt oven 15 heating the log article at 800 degrees centigrade for thirty-five minutes. The application of heat causes the vermiculite to expand interlinking the combined formulation into a viable solid. The solid article 16 is then dipped in paint 17 as a base coat and dried 18 at a secondary low temperature oven before spray coating 19 of a natural “bark” color is applied in the color application process step.

The painted log 20 is then dried again and then completed for shipment.

It will be evident from the above description that the present improved method and article formation of the invention provides not only a superior product to the currently available fiber logs, but will compare favorably with cement logs for color and realism due to the unique multiple molding step process and log formulation. Additionally, production efficiency and cost savings are achieved given that a smaller number of molds 11 are required due to the relatively short mold time of the process thus freeing the molds for reuse in a faster return cycle.

An alternate formulation can be used to achieve similar results in which fly ash (FA) can be used as replacement for one-half the (KC).

The finished product produced under this invention weighs only 30% more than comparable fiber logs and 65% less than a concrete log of the same dimension. The logs of the invention having high color and structural detail show no signs of degradation or thermal shock when exposed to 1,800 degrees for twenty minutes and then 800 degrees for eight hours which is atypical for a test criteria of artificial log environment. The logs do not require any additional reinforcing material for strength and will provide a better aesthetic “glow” than fiber with better detail than prior art fiber or cement due to a more consistent mold process.

It will thus be seen that a new and novel artificial fireplace log formulation and method of manufacturing has been illustrated and described and it will be apparent to those skilled in the art that various changes and modifications may be made therein without departing from the spirit of the invention.

I claim:

1. A method for producing an decorative, fire-resistant article comprising the steps of:
forming a mixed batch of processed vermiculite, colloidal silica and kaolin clay;
placing a measure of said mixed batch into a receptacle;
placing said receptacle in a first environment having first ambient temperatures of less than zero degrees Celsius to form an article in a first state; and
placing said article in said first state in a second environment having second ambient temperatures which are higher than said first ambient temperatures for transforming said article in said first state into an article in a second state.

2. The method of claim 1 wherein said first ambient temperatures are less than −20 degrees Celsius, and said second temperatures are greater than 200 degrees Celsius.

3. The method of claim 1 wherein said second temperatures are greater than 500 degrees Celsius.

4. The method of claim 1 wherein said first ambient temperatures are less than −20 degrees Celsius, and said second temperatures are greater than 500 degrees Celsius.

5. The method of claim 1 wherein said receptacle remains in said first environment for a time and at a temperature sufficient for one or more constituents of said mixed batch to form a bonding agent for constituents of said mixed batch.

6. The method of claim 1 wherein said receptacle remains in said second environment for a time and at a temperature sufficient to cause said vermiculite of said mixed batch to expand to interlink constituents of said mixed batch into a durable, solid, three-dimensional object.

7. The method of claim 4 wherein said receptacle remains in said second environment for a time and at a temperature sufficient to cause said vermiculite of said mixed batch to expand to interlink constituents of said mixed batch into a durable, solid, three-dimensional object.

8. The method of claim 1 wherein said receptacle is a mold which forms said measure of said mixed batch into a 3-dimensional, decorative article.

9. The method of claim 5 wherein said decorative article is of the appearance of an log.

10. The method of claim 5 wherein said receptacle is a mold which forms said measure of said mixed batch into a 3-dimensional, decorative article.

11. The method of claim 5 wherein said decorative article is of the appearance of an log.

12. The method of claim 6 wherein said receptacle is a mold which forms said measure of said mixed batch into a 3-dimensional, decorative article.

13. The method of claim 6 wherein said decorative article is of the appearance of an log.

14. An artificial fireplace log made by the steps of:
forming a mixed batch of processed vermiculite, colloidal silica and kaolin clay;
placing a measure of said mixed batch into a receptacle;
placing said receptacle in a first environment having first ambient temperatures of less than zero degrees Celsius to form an article in a first state; and
placing said article in said first state in a second environment having second ambient temperatures which are higher than said first ambient temperatures for transforming said article in said first state into an article in a second state.

15. The artificial fireplace log of claim 14 wherein said first ambient temperatures are less than −20 degrees Celsius, and said second temperatures are greater than 200 degrees Celsius.

16. The artificial fireplace log of claim 14 wherein said second temperatures are greater than 500 degrees Celsius.

17. The artificial fireplace log of claim 14 wherein said first ambient temperatures are less than −20 degrees Celsius, and said second temperatures are greater than 500 degrees Celsius.

18. The artificial fireplace log of claim 14 wherein said receptacle remains in said first environment for a time and at a temperature sufficient for one or more constituents of said mixed batch to form a bonding agent for constituents of said mixed batch.

19. The artificial fireplace log of claim 14 wherein said receptacle remains in said second environment for a time and at a temperature sufficient to cause said vermiculite of said mixed batch to expand to interlink constituents of said mixed batch into a durable, solid, three-dimensional object.

20. The artificial fireplace log of claim 14 wherein said receptacle remains in said second environment for a time and at a temperature sufficient to cause said vermiculite of said mixed batch to expand to interlink constituents of said mixed batch into a durable, solid, three-dimensional object.
